(19) United States
(12) Patent Application Publication
(10) Pub. No.: US 2018/0226647 A1
(43) Pub. Date: Aug. 9, 2018

(54) POSITIVE ELECTRODE ACTIVE MATERIAL AND LITHIUM SECONDARY BATTERY USING SAME

(71) Applicant: TOYOTA JIDOSHA KABUSHIKI KAISHA, Toyota-shi (JP)

(72) Inventor: Akira TSUJIKO, Miyoshi-shi (JP)

(73) Assignee: TOYOTA JIDOSHA KABUSHIKI KAISHA, Toyota-shi (JP)

(21) Appl. No.: 15/869,316

(22) Filed: Jan. 12, 2018

(30) Foreign Application Priority Data
Feb. 9, 2017 (JP) 2017-022414

(51) Int. Cl. H01M 4/525; H01M 10/052; H01M 4/505

(52) U.S. Cl. CPC H01M 4/525; H01M 2004/028; H01M 4/505; H01M 10/052

(57) ABSTRACT

According to the present invention, there is provided a positive electrode active material for a lithium secondary battery, including a lithium manganese complex oxide having a spinel structure. In the lithium manganese complex oxide, the ratio (A/B) of a peak intensity A at 654 eV of the Mn-L absorption edge and a peak intensity B at 537.5 eV of the O-K absorption edge, which are measured by X-ray absorption fine structure (XAFS) analysis based on a total electron yield method, satisfies 0<(A/B)≤0.2.

### CROSS REFERENCE TO RELATED APPLICATIONS

This application claims priority from Japanese Patent Application No. 2017-022414 filed on Feb. 9, 2017, the entire contents of which are incorporated herein by reference.

### BACKGROUND OF THE INVENTION

### 1. Field of the Invention

The present invention relates to a positive electrode active material, and a lithium secondary battery using the same.

### 2. Description of the Related Art

For lithium secondary batteries, further improvement in performance is being studied. As an example, Japanese Patent Application Publication No. 2011-119096, Japanese Patent Application Publication No. 2014-001099, and Japanese Translation of PCT Application No. 2009-535781 discuss the correlation between the properties of a positive electrode active material and battery performance. For example, Japanese Patent Application Publication No. 2011-119096 discloses a positive electrode active material including divalent nickel in the surface layer portion of a lithium nickel complex oxide. According to the patent publication, by including divalent nickel in the surface layer portion, it is possible to enhance surface stability of the lithium nickel complex oxide and to improve high-temperature storage characteristics of the battery.

### SUMMARY OF THE INVENTION

Meanwhile, in addition to the lithium nickel complex oxide such as described above, a lithium manganese complex oxide having a spinel structure is widely used as a positive electrode active material for a lithium secondary battery. However, according to the investigation conducted by the inventors of the present invention, when a battery using the lithium manganese complex oxide is repeatedly charged and discharged under severe conditions such as high-temperature environment, manganese is eluted from the lithium manganese complex oxide and durability of the battery may decrease.

The present invention has been created to solve the above problems, and an object thereof is to provide a positive electrode active material in which the elution of manganese is better suppressed and stability is improved. Another related object is to provide a lithium secondary battery excellent in durability.

The investigation conducted by the inventors of the present invention has demonstrated that in the lithium manganese complex oxide, charging and discharging are accompanied by a change in the valence of manganese and the desorption of oxygen and by the decrease in stability of the crystal structure. However, an evaluation index that enables objective evaluation of the decrease in stability of the lithium manganese complex oxide has not yet been elucidated. Accordingly, the inventors of the present invention performed comprehensive investigation of the bonding state of manganese in the lithium manganese complex oxide and oxygen present therearound. As a result, it was found that there is a correlation between the predetermined properties of the lithium manganese complex oxide and the durability of a battery. The results of subsequent intensive investigation led to the creation of the present invention.

According to the present invention, there is provided a positive electrode active material for a lithium secondary battery, including a lithium manganese complex oxide having a spinel structure. In the lithium manganese complex oxide, a ratio (A/B) of a peak intensity A at 654 eV of a manganese (Mn)-L absorption edge and a peak intensity B at 537.5 eV of an oxygen (O)-K absorption edge, which are measured by X-ray absorption fine structure (XAFS) analysis based on a total electron yield method, satisfies 0<(A/B)≤0.2.

When the lithium manganese complex oxide satisfies 0<(A/B)≤0.2, surface exposure of manganese is suppressed, and the state of bonding between manganese and oxygen present therearound is satisfactorily maintained. Thus, in the lithium manganese complex oxide, manganese is unlikely to elute even in repeated charging and discharging, and the stability of the crystal structure can be improved.

In a preferred embodiment of the positive electrode active material disclosed herein, the lithium manganese complex oxide includes a lithium nickel manganese complex oxide. As a result, it is also possible to advantageously realize a high energy density type lithium secondary battery in which the positive electrode potential is 4.3 V (vs. Li/Li⁺) or more.

In a preferred embodiment of the positive electrode active material disclosed herein, when a total of molar ratios of metal elements, other than lithium, included in the lithium manganese complex oxide is 2, at least one of titanium, iron, and copper is included at a molar ratio of 0.11 or more and 0.15 or less. This makes it possible to improve the stability of the crystal structure more satisfactorily.

The present invention also provides a lithium secondary battery including the positive electrode active material. As a result, it is possible to realize a highly durable lithium secondary battery such that battery capacity is unlikely to decrease even in repeated charging and discharging over a long period of time.

### BRIEF DESCRIPTION OF THE DRAWINGS

FIG. 1 is a schematic view showing a longitudinal sectional structure of a lithium secondary battery according to one embodiment;

FIG. 2 is a chart representing an X-ray absorption spectrum at 635 eV to 665 eV;

FIG. 3 is a chart representing an X-ray absorption spectrum at 525 eV to 550 eV; and

FIG. 4 is a graph representing the relationship between the peak intensity ratio (A/B) and a capacity retention ratio.

### DETAILED DESCRIPTION OF THE PREFERRED EMBODIMENTS

Preferred embodiments of the present invention will be described below with reference to the drawings. Matters other than the matters (for example, a composition and properties of a positive electrode active material) particularly mentioned in the present specification, and necessary for the implementation of the present invention (for example, other battery constituting elements and general manufacturing process of the battery, which do not characterize the present invention) can be grasped as design matters for a person skilled in the art which are based on the related art in the pertinent field. The present invention can be carried out based on the contents disclosed in this specification and technical common sense in the pertinent field.

Positive Electrode Active Material for Lithium Secondary Battery

The positive electrode active material of the present embodiment includes a lithium manganese complex oxide.

The lithium manganese complex oxide is an oxide including lithium (Li) and manganese (Mn). The most typical lithium manganese complex oxide can be exemplified by LiaMn₂O₄ (where a is a real number satisfying 0<a<2), for example, LiMn₂O₄.

The lithium manganese complex oxide may include one or two or more metal elements in addition to Li and Mn. The lithium manganese complex oxide preferably includes one or two or more transition metal elements in addition to Mn. As a result, an operating potential of 4.3 V (vs. Li/Li⁺) or higher can be advantageously realized. The operating potential (vs. Li/Li⁺) of the lithium manganese complex oxide may be typically 4.5 V or more, for example, 4.7 V or more and typically 5.5 V or less, for example 5.3 V or less. With the lithium manganese complex oxide having such the operating potential, it is possible to stably realize the lithium secondary battery with a high energy density.

The lithium manganese complex oxide preferably includes one or two or more of transition metal elements belonging to the same period as Mn in the periodic table, for example, titanium (Ti), vanadium (V), chromium (Cr), iron (Fe), cobalt (Co), nickel (Ni), and copper (Cu). Among them, preferably at least one, and more preferably two or more of Ti, Fe, Ni and Cu are included. For example, among the transition metal elements belonging to the same period as Mn, a transition metal element having an atomic number smaller than that of Mn and a transition metal element having an atomic number larger than that of Mn may be included.

Characteristics of the transition metal elements belonging to the same period as Mn, such as ionization energy, electron affinity, electronegativity, and the like, are similar to those of Mn. This makes it possible to maintain the crystal structure of the lithium manganese complex oxide more stably even when lithium ions are inserted and detached as the lithium secondary battery is charged and discharged.

One preferable example of the lithium manganese complex oxide is a compound represented by the following formula (I).

Liₘ(Mn₂₋ₓM¹ₓ)Oₙ (Formula I)

In the formula (I), m is a real number satisfying 0.96≤m≤1.20; n is a real number satisfying 2≤n≤4; and x is a real number satisfying 0≤x≤1.0. When 0<x, M¹ is one or two or more elements from Sc, Ti, V, Cr, Fe, Co, Ni, Cu, Zn, Ga, Mg, Ca, Sr, Ba, Y, Al, Zr, Nb, Mo, Ru, Rh , Pd, In, Sn, La, Ce, Sm, Ta, and W.

In the formula (I), Mn is preferably a first element (an element having the largest molar ratio) among the metal elements other than Li. Further, the compound represented by the formula (I) preferably includes M¹. In other words, x is preferably 0<x<1, for example 0.5≤x≤0.8.

M¹ preferably includes one or two or more transition metal elements, and more preferably one or two or more, for example, three or more transition metal elements belonging to the same period as Mn in the periodic table. Among them, Ni is preferably included. For example, it is preferable that at least one, more preferably two or more, of Ti, Fe and Cu be contained in addition to Ni. Among the metal elements other than Li, Ni is preferably a second element (an element having the second largest molar ratio after Mn).

In a preferred embodiment, the lithium manganese complex oxide includes a lithium nickel manganese complex oxide represented by the following formula (II).

Liₘ(Mn_{2-y-z}Ni_{y}M²_{z})O₄ (Formula II)

In the formula (II), m is a real number satisfying 0.96≤m≤1.20; y is a real number satisfying 0.4≤y≤0.6; and z is a real number satisfying 0≤z≤0.6. When 0<z, M² is the same element as M¹ excluding Ni.

In the formula (II), Mn is preferably a first element. Ni is preferably a second element. Further, the compound represented by the formula (II) preferably includes M². It is preferable that z be 0<z<0.6, approximately 0.1≤z≤0.5, typically 0.1≤z≤0.2, in one example 0.11 ≤z≤0.15, and for example 0.11≤z≤0.13.

Further, similarly to M¹, M² preferably includes one or two or more, for example, three or more transition metal elements belonging to the same period as Mn or Ni in the periodic table. Among them, it is preferable that one or two or more of Ti, Fe and Cu be included. When M² includes two or more elements, the molar ratio of these elements is preferably about the same (for example, the difference in molar ratio is 0.05 or less, preferably 0.02 or less). This makes it possible to more stably maintain the crystal structure of the lithium nickel manganese complex oxide.

In the formula (II), for convenience sake, the composition ratio of oxygen (O) is expressed as an integer, but this numerical value should not be interpreted strictly, and fluctuations (for example, fluctuations of about ±20%) attributable to the stability of the crystal structure and the like are allowed.

The lithium manganese complex oxide has a spinel type crystal structure. The crystal structure of the lithium manganese complex oxide can be determined by the conventional well-known X-ray diffraction (XRD) measurements.

The average particle size (volume-averaged D₅₀ value based on laser diffraction-scattering method) of the lithium manganese complex oxide is not particularly limited. From the viewpoint of handleability and workability, the average particle is generally about 1 μm to 20 μm, for example, about 5 μm to 10 μm.

In the lithium manganese complex oxide of the present embodiment, the ratio (A/B) of a peak intensity A of the Mn-L absorption edge to a peak intensity B of the O-K absorption edge, which are measured by XAFS, satisfies 0<(A/B)≤0.2.

Specific measurement conditions of XAFS will be described hereinbelow in detail, but the X-ray penetration depth in XAFS is about several tens of nanometers. Therefore, the A/B can be said to be an evaluation index reflecting the local structure of manganese element and oxygen element present in the region which is several tens of nanometers deep from the outermost surface of the lithium manganese complex oxide. That is, the lithium manganese complex oxide satisfying (A/B)≤0.2 has a small ratio (A/B) of the peak intensity A of the Mn-L absorption edge to the peak intensity B of the O-K absorption edge, that is, the surface exposure of manganese is suppressed as compared with the lithium manganese complex oxide not satisfying this ratio.

In the present embodiment, the ratio (A/B) is approximately 0.001 or more, typically 0.01 or more, in one example 0.1 or more, for example 0.12 or more, and typically 0.15 or less. This makes it possible to improve the stability of the crystal structure more satisfactorily.

Conventionally, a coating layer made of an inorganic material or an organic material has been formed on the surface of a lithium manganese complex oxide for the purpose of suppressing the elution of manganese from the lithium manganese complex oxide. However, the lithium manganese complex oxide repeatedly expands and contracts in the course of charging and discharging. Therefore, there is concern that the coating layer will peel little by little in the course of charging and discharging, and the effect of the coating will be lost. There is also concern that when the ion conductivity and/or electron conductivity of the coated material is low, the internal resistance of the battery will increase and battery characteristics such as a high-rate charge/discharge characteristic will deteriorate.

Compared to these conventional methods, since the lithium manganese complex oxide of the present embodiment has no coating layer on the surface, a high effect of suppressing elution of manganese is maintained after repeated charging and discharging. Therefore, it can be said that from the viewpoint of stably maintaining the lithium manganese complex oxide, the technology disclosed herein is more advantageous.

The lithium manganese complex oxide of the present embodiment can be produced, for example, by a liquid phase method such as sol-gel method or co-precipitation method. As a preferred example, the following production method can be mentioned.

First, a supply source of a metal element other than Li constituting the lithium manganese complex oxide is weighed so as to obtain a desired composition ratio, and mixed with an aqueous solvent to prepare an aqueous solution. The supply source of the metal element can include a manganese salt as a necessary component and also a metal salt such as a nickel salt. The anion of the metal salts may be selected so that each salt has the desired water solubility. Examples of the anion of the metal salt include sulfate ion, nitrate ion, carbonate ion and the like.

Next, a basic aqueous solution having a pH of 11 to 14 is added to this aqueous solution to neutralize it, and a hydroxide containing the above metal element is precipitated to obtain a sol-like raw material hydroxide (precursor). As the basic aqueous solution, for example, an aqueous sodium hydroxide solution, ammonia water and the like can be used.

Next, the raw material hydroxide is mixed with a lithium supply source and calcined in an atmosphere of an oxygen-containing gas (for example, in the air atmosphere). As the lithium supply source, for example, lithium carbonate, lithium hydroxide, lithium nitrate and the like can be used. The calcination temperature (maximum calcination temperature) can be, for example, 700° C. to 1000° C. and preferably 800° C. to 1000° C. The calcination time (holding time at the highest calcination temperature) can be approximately 1 h to 20 h, for example 1 h to 15 h. Then, the obtained calcined product is cooled and appropriately pulverized, whereby a lithium manganese complex oxide can be produced.

Lithium Secondary Battery

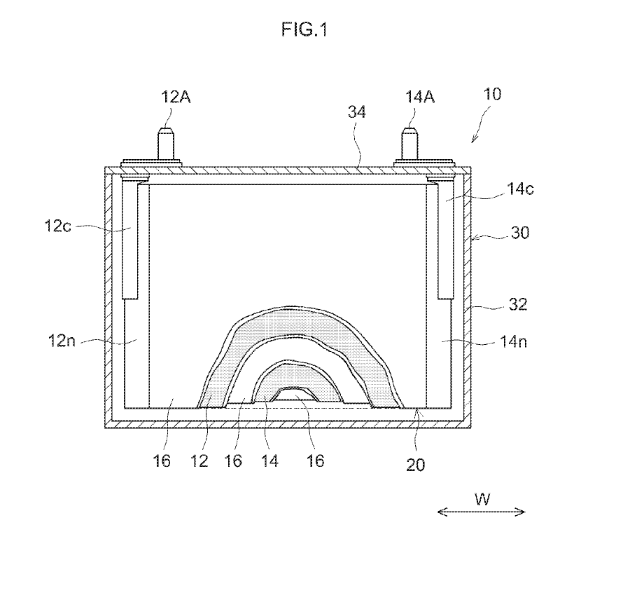

FIG. 1 is a schematic diagram showing a longitudinal sectional structure of a lithium secondary battery 10 according to one embodiment. The configuration of the lithium secondary battery will be described with reference to FIG. 1 as an example, but this configuration is not particularly limiting. In the following drawings, the same reference numerals are attached to the members and parts that exhibit the same action, and redundant explanation may be omitted or simplified. The dimensional relationship (length, width, thickness, etc.) in the drawings does not necessarily reflect the actual dimensional relationship.

The lithium secondary battery 10 is configured by accommodating an electrode body 20 and a nonaqueous electrolyte (not shown) in a battery case 30. The battery case 30 is provided with a battery case main body 32 and a lid body 34 for closing the opening thereof. A positive electrode terminal 12A and a negative electrode terminal 14A protrude from the top of the lid body 34. The material of the battery case 30 is not particularly limited and is, for example, a lightweight metal such as aluminum. The battery case 30 has a bottomed rectangular parallelepiped shape (angular shape). However, the battery case 30 may have a cylindrical shape and the like, or may be in the form of a bag made of a laminate film.

The electrode body 20 has a strip-shaped positive electrode 12, a strip-shaped negative electrode 14, and a strip-shaped separator 16. The electrode body 20 of the present embodiment is a wound electrode body obtained by laminating the positive electrode 12 and the negative electrode 14 with the separator 16 interposed therebetween and winding the laminate in the longitudinal direction. However, the electrode body 20 may be a laminated electrode body in which a rectangular positive electrode and a rectangular negative electrode are laminated with a rectangular separator interposed therebetween.

The positive electrode 12 includes a positive electrode current collector and a positive electrode active material layer fixed to the surface thereof. A conductive member made of a metal having good conductivity (for example, aluminium and nickel) is suitable as the positive electrode current collector. The positive electrode active material layer is formed with a predetermined width along the width direction W on the surface of the positive electrode current collector. The positive electrode active material layer includes a positive electrode active material. The positive electrode active material includes the lithium manganese complex oxide described hereinabove. In addition to the lithium manganese complex oxide, the positive electrode active material may contain a conventional well-known positive electrode active material, for example, a lithium transition metal complex oxide having a layered structure or an olivine structure. The positive electrode active material layer may include components other than the positive electrode active material, for example, a conductive material, a binder, an inorganic phosphoric acid compound, and the like. The conductive material can be exemplified by a carbon material such as acetylene black. The binder can be exemplified by a halogenated vinyl resin such as polyvinylidene fluoride (PN/dF).

The negative electrode 14 includes a negative electrode current collector and a negative electrode active material layer fixed to the surface thereof. A conductive material composed of a metal having good conductivity (for example, copper, nickel and the like) is suitable as the negative electrode current collector. The negative electrode active material layer is formed with a predetermined width along the width direction W on the surface of the negative electrode current collector. The negative electrode active material layer includes a negative electrode active material. For example, a graphite-based carbon material such as natural graphite, artificial graphite, amorphous coated graphite (one in which amorphous carbon is coated on the surface of graphite particles) is suitable as the negative electrode active material. The negative electrode active material layer may include components other than the negative electrode active material, for example, a thickener and a binder. The thickener can be exemplified by a cellulose such as carboxymethylcellulose (CMC). The binder can be exemplified by a rubber such as styrene butadiene rubber (SBR), a halogenated vinyl resin such as polyvinylidene fluoride (PVdF).

A positive electrode active material layer non-formation portion 12n in which the positive electrode active material layer is not formed is provided at one end portion (the left side end portion in FIG. 1) of the positive electrode current collector in the width direction W. The positive electrode 12 is electrically connected to a positive electrode terminal 12A through a positive electrode current collecting plate 12c provided at the positive electrode active material layer non-formation portion 12n. Further, a negative electrode active material layer non-formation portion 14n in which the negative electrode active material layer is not formed is provided at one end portion (the right side end portion in FIG. 1) of the negative electrode current collector in the width direction W. The negative electrode 14 is electrically connected to a negative electrode terminal 14A through a negative electrode current collecting plate 14c provided at the negative electrode active material layer non-formation portion 14n.

The separator 16 is disposed between the positive electrode 12 and the negative electrode 14. The separator 16 insulates the positive electrode active material layer and the negative electrode active material layer. The separator 16 is configured to be porous so that charge carriers can pass therethrough. The separator 16 can be exemplified by a sheet made of a resin such as polyethylene (PE) and polypropylene (PP). The separator 16 may have a porous heat-resistant layer including inorganic compound particles (inorganic filler) for the purpose of preventing internal short circuit and the like.

The nonaqueous electrolyte is, for example, a nonaqueous electrolytic solution including a nonaqueous solvent and a supporting salt. However, the nonaqueous electrolyte may be in a polymer state or a gel state. In that case, the electrode body 20 may not have the separator 16.

Examples of the nonaqueous solvent include carbonates, ethers, esters, nitriles, sulfones, lactones, and the like. Among them, a fluorine-containing nonaqueous solvent including a fluorine atom and having high oxidation resistance (high oxidation potential) is preferable. As a preferred example, fluorinated carbonates, for example, fluorinated cyclic carbonates such as monofluoroethylene carbonate (MFEC), fluorinated chain carbonates such as monofluoromethyl difluoromethyl carbonate (F-DMC) and (2,2,2-trifluoroethyl)methyl carbonate (TFEMC) can be mentioned. By using a fluorine-containing nonaqueous solvent, oxidative decomposition of the nonaqueous electrolyte in the positive electrode can be advantageously suppressed even when a positive electrode active material having a high operation upper limit potential is used.

The supporting salt dissociates in a nonaqueous solvent to produce a charge carrier. The supporting salt can be exemplified by lithium salts such as LiPF₆ and LiBF₄. In addition to the nonaqueous solvent and the supporting salt, the nonaqueous electrolyte may include various kinds of additives such as a film forming agent, e.g., lithium bis(oxalate) borate (LiBOB) and vinylene carbonate (VC), a dispersant, a thickening agent, and the like.

Use of Lithium Secondary Battery

The lithium secondary battery of the present embodiment has higher durability than conventional products. Although the lithium secondary battery of this embodiment can be used for various purposes, the advantageous use thereof is as a power source (driving power source) for a motor mounted on a vehicle such as a plug-in hybrid vehicle (PHV), a hybrid vehicle (HV), and an electric vehicle (EV). Typically, lithium secondary batteries are used in the form of a battery pack in which a plurality of lithium secondary batteries are electrically connected in series and/or in parallel.

Several examples relating to the present invention will be described below, but the present invention is not intended to be limited to such examples.

Preparation of Lithium Secondary Battery

First, metal sources (metal sulfates) other than Li were dissolved in water so as to obtain the element ratio shown in Table 1. Sodium hydroxide was added thereto, and the mixture was stirred while neutralizing to obtain a raw material hydroxide. This raw material hydroxide was mixed with lithium carbonate so as to obtain the element ratio (Li ratio) shown in Table 1, calcined for 15 hat 900° C. in the air atmosphere and then pulverized with a ball mill to obtain lithium nickel manganese complex oxide with an average particle diameter of 10 μm (NiMn spinel, Examples 1 to 8).

The chemical formula of the lithium nickel manganese complex oxide of each example is presented below.
Example 1: Li_{1.1}Mn_{1.37}Ni_{0.5}Cu_{0.03}Ti_{0.05}Fe_{0.05}O₄
Example 2: Li_{1.1}Mn_{1.37}Ni_{0.5}Cu_{0.05}Ti_{0.05}Fe_{0.03}O₄
Example 3: Li_{1.1}Mn_{1.39}Ni_{0.5}Cu_{0.03}Ti_{0.03}Fe_{0.05}O₄
Example 4: Li_{1.1}Mn_{1.35}Ni_{0.5}Cu_{0.05}Ti_{0.05}Fe_{0.05}O₄
Example 5: Li_{1.1}Mn_{1.40}Ni_{0.5}Cu_{0.05}Ti_{0.05}O₄
Example 6: Li_{1.1}Mn_{1.40}Ni_{0.5}Ti_{0.05}Fe_{0.05}O₄
Example 7: Li_{1.1}Mn_{1.40}Ni_{0.5}Ti_{0.05}Fe_{0.05}O₄
Example 8: Li_{1.1}Mn_{1.50}Ni_{0.5}O

That is, in Examples 1 to 8, m in the above formula (II) is 1.1, y is 0.5, z is 0 to 0.15, and when 0<z, M² is at least one of Cu, Ti and Fe.

Next, positive electrodes were prepared using the NiMn spinets of Examples 1 to 8 as positive electrode active materials. Specifically, first, the NiMn spinet, acetylene black (AB) as a conductive material, and polyvinylidene fluoride (PVdF) as a binder were mixed in a mass ratio of NiMn spine:AB:PVdF=87:10:3, and then mixed with N-methyl-2-pyrrolidone (NMP) to prepare a positive electrode slurry. The positive electrode slurry was applied to both surfaces of a strip-shaped aluminum foil (positive electrode current collector) and dried to prepare a positive electrode (Examples 1 to 8) having a positive electrode active material layer on both sides of the positive electrode current collector.

Next, a negative electrode was prepared. Specifically, first, natural graphitic carbon (C) as a negative electrode active material, styrene butadiene rubber (SBR) as a binder, and carboxymethyl cellulose (CMC) as a thickener were mixed at a mass ratio of C:SBR:CMC=98:1:1 and mixed with water to prepare a negative electrode slurry. The negative electrode slurry was coated on both surfaces of a strip-shaped copper foil (negative electrode current collector) and dried to prepare a negative electrode having a negative electrode active material layer on both sides of the negative electrode current collector.

Next, the positive electrode and the negative electrode prepared above were laminated with a separator (here, a three-layer structure of PP/PE/PP in which polypropylene (PP) was laminated on both sides of polyethylene (PE) was used) interposed therebetween, and the laminate was wound in a flat oval shape to prepare a wound electrode body (Examples 1 to 8).

Next, a nonaqueous electrolytic solution was prepared. Specifically, monofluoroethylene carbonate (MFEC) as a fluorinated cyclic carbonate and monofluoromethyl difluoromethyl carbonate (F-DMC) as a fluorinated chain carbonate were mixed at a volume ratio of MFEC : F-DMC=50:50 to obtain a mixed solvent, and LiPF₆ as a supporting salt was dissolved in the mixed solvent at a concentration of 1.0 mol/L to prepare a nonaqueous electrolytic solution.

Next, the produced wound electrode body and the prepared nonaqueous electrolytic solution were housed in a flat battery case, and the battery case was sealed. Then, the battery case was pressurized so that the restraint pressure per unit area of the wound electrode body was 15 kg/cm².

Assemblies (Examples 1 to 8) were thus constructed.

Activation Treatment

The assemblies thus constructed were subjected to constant-current charging (CC charging) at a charging rate of 1/5C in a temperature environment of 25° C. until the voltage between the positive and negative electrodes reached 4.9 V. After that, constant-voltage charging (CV charging) was performed until the current value reached 1/50C, and the battery was fully charged. Thereafter, constant-current discharging (CC discharging) was performed at a discharging rate of 1/5C until the voltage between the positive and negative electrodes reached 3.5 V, and the CC discharging capacity at this time was taken as the initial capacity. Here, “1C” was taken as the value of the current that can fully charge, in 1 h, the battery capacity (design capacity) estimated from the amount of the positive electrode active material.

Lithium secondary batteries of Examples 1 to 8 were thus manufactured. In the lithium secondary batteries of Examples 1 to 8, only the positive electrode active material is different.

High-Temperature High-Rate Cycle Test (60° C.)

The above batteries were placed in a thermostat at 60° C. and subjected to a high-temperature high-rate cycle test. Specifically, as one cycle, CC charging was performed at a charging rate of 2C until the voltage between the positive and negative electrodes reached 4.9 V, and then CC discharging was performed at a discharging rate of 2C until the voltage between the positive and negative electrodes reached 3.5 V, and 200 cycles were repeated. Then, in the same manner as the initial capacity, the battery capacity (CC discharging capacity) after the high-temperature cycle test was measured and the capacity retention ratio (%) was calculated. The results are shown in Table 1.

Measurement of Mn Elution Amount

The batteries subjected to the high-temperature cycle test were disassembled and the negative electrodes were taken out. Next, the amount of manganese precipitated on the negative electrode was measured by plasma emission spectrometry (ICP: Inductively Coupled Plasma). Then, the amount (mg) of Mn detected at the negative electrode was divided by the active material weight (mg) of the positive electrode opposed to the negative electrode to obtain a normalized Mn elution amount (mg/mg) from the positive electrode active material. The results are shown in Table 1.

XAFS Measurement

Further, cells for XAFS measurement were separately constructed, subjected to activation treatment in the same manner as described above, and then disassembled in a glove box with a dew point controlled to −80° C. or lower, and positive electrodes were removed therefrom. Next, the positive electrodes were transferred to a sample transporting apparatus in a glove box, and introduced into a XAFS measuring apparatus in a state where the positive electrodes were kept out of contact with the atmosphere. Then, the X-ray absorption spectrum was measured.
Detection method: total electron yield method
Measurement absorption edge: Mn L absorption edge, O-K absorption edge

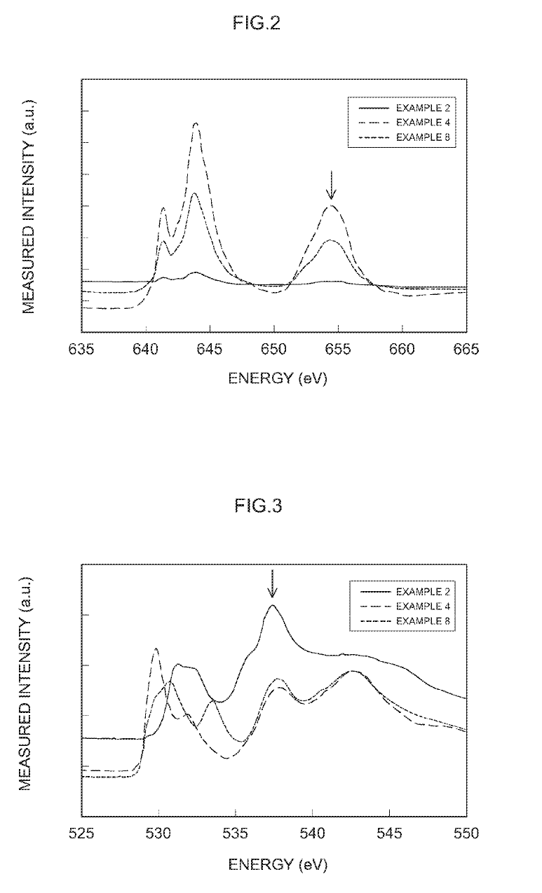

As representative examples, the X-ray absorption spectra of Examples 2, 4 and 8 are shown in FIGS. 2 and 3. FIG. 2 is a chart representing an X-ray absorption spectrum in an energy region of 635 eV to 665 eV. In FIG. 2, an arrow is shown at a position of 654 eV. FIG. 3 is a chart representing an X-ray absorption spectrum in an energy region of 525 eV to 550 eV. In FIG. 3, an arrow is shown at a position of 537.5 eV.

Then, curve fitting was performed with respect to the obtained X-ray absorption spectrum with the peak position and the peak fit range in the following energy region, and peak intensities A and B were obtained.
Peak intensity A of Mn: peak position (654 eV), peak fit range (650 eV to 658 eV)
Peak intensity B of O: peak position (537.5 eV, 542.5 eV), peak fit range (535 eV to 560 eV)

Specifically, curve fitting was performed with respect to each measured energy by using the peak height, the half-value width, and the baseline (base) as parameters, so as to minimize the sum total of squares of the difference between the actually measured detected intensity (measured intensity) and the detected intensity obtained from the following equation (a).

[Math. 1]

Detected intensity={(Peak height)/[1+(Measured energy−Peak position)²/(Half width)²]}+Base (Equation (a))

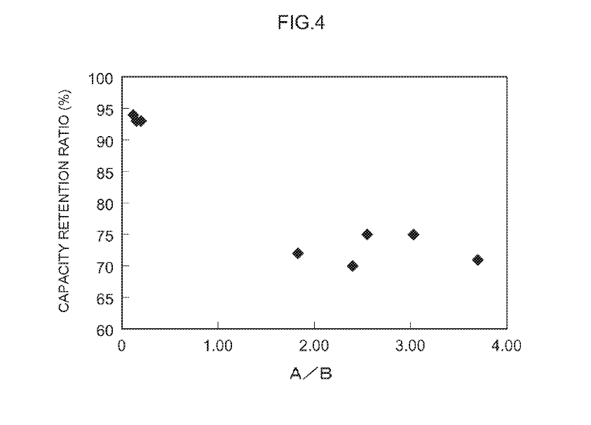

The results are shown in Table 1. In addition, FIG. 4 represents the relationship between the peak intensity ratio A/B determined by XAFS and the capacity retention ratio.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Positive | Li | 1.1 | 1.1 | 1.1 | 1.1 | 1.1 | 1.1 | 1.1 | 1.1 |
| electrode | Mn | 1.37 | 1.37 | 1.39 | 1.35 | 1.40 | 1.40 | 1.47 | 1.50 |
| active | Ni | 0.50 | 0.50 | 0.50 | 0.50 | 0.50 | 0.50 | 0.50 | 0.50 |
| material | Cu | 0.03 | 0.05 | 0.03 | 0.05 | 0.05 | — | 0.03 | — |
| (molar | Ti | 0.05 | 0.05 | 0.03 | 0.05 | 0.05 | 0.05 | — | — |
| ratio) | Fe | 0.05 | 0.03 | 0.05 | 0.05 | — | 0.05 | — | — |
| | Cu + Ti + Fe | 0.13 | 0.13 | 0.11 | 0.15 | 0.1 | 0.1 | 0.03 | 0 |
| XAFS of | Peak | 0.061 | 0.114 | 0.117 | 0.918 | 1.103 | 1.618 | 1.535 | 1.699 |
| positive | intensity A | | | | | | | | |
| electrode | (Mn − L | | | | | | | | |
| | absorption | | | | | | | | |
| | edge) | | | | | | | | |
| | Peak | 0.507 | 0.766 | 0.584 | 0.502 | 0.459 | 0.635 | 0.507 | 0.459 |
| | intensity B | | | | | | | | |
| | (O − K | | | | | | | | |
| | absorption | | | | | | | | |
| | edge) | | | | | | | | |
| | A/B | 0.12 | 0.15 | 0.20 | 1.83 | 2.40 | 2.55 | 3.03 | 3.70 |

| | | | | | | | | |
|---|---|---|---|---|---|---|---|---|
| Capacity retention | 94 | 93 | 93 | 72 | 70 | 75 | 75 | 71 |
| ratio (%) | | | | | | | | |
| Mn elution | 0.21 | 0.19 | 0.22 | 0.60 | 0.70 | 0.65 | 0.85 | 0.60 |
| amount (mg/mg) | | | | | | | | |

As shown in Table 1, in Examples 1 to 3 in which A/B was in the range of 0.2 or less, elution of Mn from the positive electrode active material was relatively suppressed as compared with other examples. This is apparently because in the positive electrode active materials of Examples 1 to 3. the surface exposure of manganese is suppressed and the bonding state of manganese and oxygen present therearound is satisfactorily maintained.

Also, as shown in Table 1 and FIG. 4, the capacity retention ratio of the lithium secondary batteries of Examples 1 to 3 was high. That is, capacity deterioration after repeated high-rate charging and discharging under a high-temperature environment was small. Such results indicate the technical significance of the technique disclosed herein.

Although the present invention has been described in detail, the above-described embodiments and examples are merely exemplary, and the invention disclosed herein includes various modifications and changes of the above specific examples.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principle of the present invention. These preferred embodiments are provided with the understanding that they are not intended to limit the present invention to the preferred embodiments described in the specification and/or shown in the drawings. The present invention is not limited to the preferred embodiment described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A positive electrode active material for a lithium secondary battery, the positive electrode active material comprising a lithium manganese complex oxide having a spinel structure, wherein
in the lithium manganese complex oxide, a ratio (A/B) of a peak intensity A at 654 eV of a manganese (Mn)-L absorption edge and a peak intensity B at 537.5 eV of an oxygen (O)-K absorption edge, which are measured by X-ray absorption fine structure (XAFS) analysis based on a total electron yield method, satisfies 0≤(A/B)≤0.2.

2. The positive electrode active material according to claim 1, wherein the lithium manganese complex oxide includes a lithium nickel manganese complex oxide that includes nickel.

3. The positive electrode active material according to claim 1, wherein, when a total of molar ratios of metal elements, other than lithium, included in the lithium manganese complex oxide is 2, at least one of titanium, iron, and copper is included at a molar ratio of 0.11 or more and 0.15 or less.

4. A lithium secondary battery comprising the positive electrode active material according to claim 1.
